(19) United States
(12) Patent Application Publication
(10) Pub. No.: US 2022/0415192 A1
(43) Pub. Date: Dec. 29, 2022

(54) METHOD FOR COLLECTING FLIGHT DATA FROM AIRCRAFT

(71) Applicant: Airbus SAS, BLAGNAC (FR)

(72) Inventor: Benoit SALGUES, BLAGNAC (FR)

(21) Appl. No.: 17/840,837

(22) Filed: Jun. 15, 2022

(30) Foreign Application Priority Data
Jun. 24, 2021 (FR) 2106729

(51) Int. Cl. G08G 5/00

(52) U.S. Cl. CPC G08G 5/0078; G08G 5/0008; G08G 5/0013; G08G 5/003

(57) ABSTRACT

A method for collecting flight data from aircraft. Each aircraft in a set of collecting aircraft collects information of ADS-B type received from other aircraft and associates contextual information with the received information of ADS-B type. Additionally, each aircraft in the set of collecting aircraft transmits the received information of ADS-B type, as well as the associated contextual information, to a common server. The common server receives and stores the information transmitted by the various aircraft in the set of collecting aircraft. The stored information is filtered so as to exclude information of ADS-B type which is incoherent taking into account contextual information. At least some of the filtered information is transmitted to a user.

### CROSS-REFERENCES TO RELATED APPLICATIONS

This application claims the benefit of French patent application No. 2,106,729 filed on Jun. 24, 2021, the entire disclosures of which are incorporated herein by way of reference.

### FIELD OF THE INVENTION

The invention pertains to the field of collecting flight data from aircraft, more particularly information of ADS-B (Automatic Dependent Surveillance-Broadcast) type.

### BACKGROUND OF THE INVENTION

The majority of modern aircraft are equipped with a transponder of ADS-B type which regularly broadcasts, on a radio communication frequency, information relating to the transmitting aircraft, such as, for example, its identification, its position, its speed etc. This information can be received by surrounding aircraft or by ground stations (air traffic control etc.) which are thus aware of the situation of the aircraft transmitting said information. There are ground stations which collect information of ADS-B type transmitted by aircraft flying near said ground stations and which transmit this information to a platform which centralizes and stores the information of ADS-B type originating from ground stations installed at many sites around the world. The information stored by such a platform makes it possible to be aware of worldwide aircraft traffic, notably the trajectories of the aircraft. However, the reliability of the information stored by such a platform is not guaranteed. Specifically, there are several thousand ground stations in the world which transmit information of ADS-B type to such a platform. Among these many ground stations, some can sometimes be subject to a malfunction and, for example, transmit the information of ADS-B type to the platform with a delay, thereby causing asynchronism in the information stored by the platform. In addition, it is not possible to exclude the existence of a malicious ground station which would send information of ADS-B type which would be false, distorted or partial to the platform, or indeed of a malicious transmitter of information of ADS-B type which would transmit information corresponding to fictitious positions of an aircraft. Consequently, there is a need to be able to guarantee the reliability of the information stored by such a platform.

### SUMMARY OF THE INVENTION

The aim of the present invention is notably to provide a solution to this problem. It relates to a method for collecting flight data from aircraft which comprises the following steps:
each aircraft in a set of collecting aircraft collecting information of ADS-B type received from other aircraft;
on board each aircraft in the set of collecting aircraft, associating contextual information with the information of ADS-B type received by this aircraft;
each aircraft in the set of collecting aircraft transmitting the received information of ADS-B type, as well as the associated contextual information, to a common server;
the common server receiving and storing the information transmitted by the various aircraft in the set of collecting aircraft;
filtering the information stored by the common server so as to exclude information of ADS-B type which is incoherent taking into account contextual information; and
transmitting at least some of the filtered information to a user.

Thus, the information stored by the common server comprises not only information of ADS-B type, but also associated contextual information, added by the aircraft in the set of collecting aircraft which received this information of ADS-B type and which re-transmitted it to the common server. By virtue of this, the method in accordance with the invention can exclude information of ADS-B type which is incoherent during the filtering step, thereby making it possible to improve the reliability of the information transmitted to the user. The method in accordance with the invention further makes it possible to cover areas not provided with ground stations, for example ocean areas. Specifically, information of ADS-B type can be received by aircraft in the set of collecting aircraft flying in any area of the world, in particular in an ocean area. This information of ADS-B type is then transmitted by these aircraft in the set of collecting aircraft, with the associated contextual information, to the common server. The set of collecting aircraft under consideration consists of aircraft, each of which is configured to collect information of ADS-B type received from other aircraft, to associate contextual information with the received information of ADS-B type and to make it possible to transmit the received information of ADS-B type, as well as the associated contextual information, to the common server.

According to various embodiments, which can be taken in isolation or in combination:
the contextual information comprises at least one piece of information on the position of the aircraft in the set of collecting aircraft which received the information of ADS-B type with which the contextual information is associated;
the contextual information comprises a piece of information on the time at which the information of ADS-B type was received by the aircraft in the set of collecting aircraft which received this information of ADS-B type with which the contextual information is associated;
the method further comprises, on the one hand, a step of signing, on board an aircraft in the set of collecting aircraft, the information of ADS-B type received by this aircraft, before transmitting it to the common server and, on the other hand, a step of checking the authenticity and/or the integrity of the information received by the common server, on the basis of said signature.

Advantageously, the signing step further comprises signing the contextual information associated with the information of ADS-B type received by said aircraft;
the step of filtering the information stored by the common server comprises excluding information of ADS-B type which is not coherent with other information of ADS-B type stored by the common server taking into account contextual information or which is not coherent with contextual information associated with this information of ADS-B type;
the method further comprises a step of aggregating the filtered information.

Advantageously, the aggregating step comprises determining at least one trajectory of an aircraft;
the common server is located on the ground;
the common server forms part of a platform for collecting operating data from the aircraft in the set of collecting aircraft;
an aircraft in the set of collecting aircraft transmits the information to the common server by means of an on-board system for storing and for communicating information of said aircraft; and
the method comprises a step of determining at least one indicator of the quality of the aggregated data.

### BRIEF DESCRIPTION OF THE DRAWINGS

The invention will be better understood upon reading the following description and upon studying the appended figures.

FIG. 1 is a schematic view illustrating one embodiment of a data collection method in accordance with the invention.

FIG. 2 is a schematic view illustrating one embodiment of a data collection method in accordance with the invention.

FIG. 3 schematically illustrates an aircraft belonging to a set of collecting aircraft involved in a data collection method in accordance with one embodiment of the invention.

FIG. 4 illustrates a data collection method in accordance with one embodiment of the invention.

### DETAILED DESCRIPTION OF THE PREFERRED EMBODIMENTS

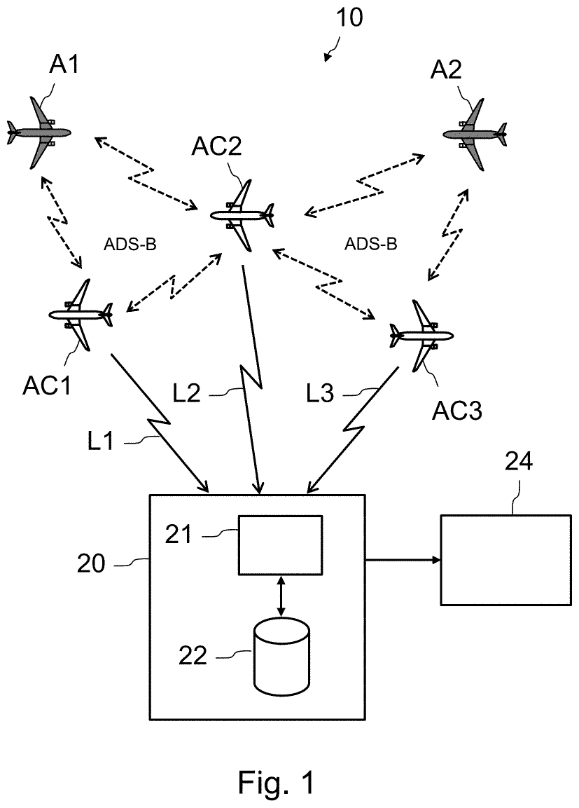

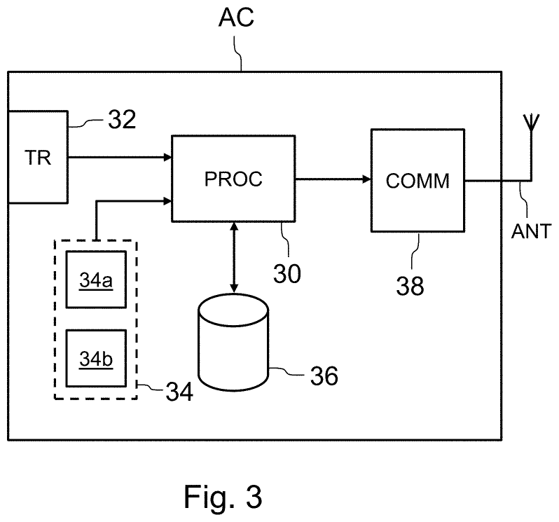

FIG. 1 shows an airspace 10 through which aircraft AC1, AC2, AC3 belonging to a set of collecting aircraft, as well as aircraft A1, A2 not belonging to this set of collecting aircraft, are travelling. These various aircraft are each equipped with an ADS-B transponder, so that each aircraft repeatedly transmits information of ADS-B type (a function referred to as the “ADS-B Out” function of the transponder). Each aircraft also receives, by virtue of its transponder, information of ADS-B type transmitted by other aircraft which are close enough to it to make it possible to receive said information (a function referred to as the “ADS-B In” function of the transponder). Thus, in the example illustrated in the figure, the aircraft A1 receives, if it is equipped for this purpose, information of ADS-B type transmitted by the aircraft AC1 and AC2, the aircraft AC1 receives information of ADS-B type transmitted by the aircraft A1 and AC2, the aircraft AC2 receives information of ADS-B type transmitted by the aircraft A1, AC1, A2 and AC3, the aircraft A2 receives, if it is equipped for this purpose, information of ADS-B type transmitted by the aircraft AC2 and AC3, and the aircraft AC3 receives information of ADS-B type transmitted by the aircraft A2 and AC2. As shown in FIG. 3, each aircraft AC from among the aircraft AC1, AC2 and AC3 which belong to this set of collecting aircraft comprises a processing unit 30 (labelled PROC in the figure) connected at its input to the ADS-B transponder 32 (labelled TR in the figure) and to a set of sources of information 34 comprising at least one source of information on the position 34a of the aircraft. As is known, a processing unit comprises a processor.

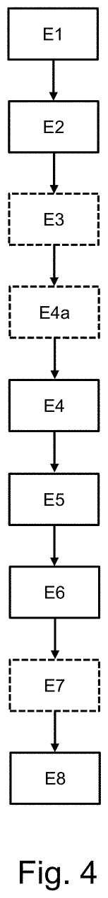

In operation, in a step E1 of a method for collecting flight data from aircraft as illustrated in FIG. 4, the processing unit 30 collects the information of ADS-B type received from the other aircraft by the transponder 32 and, in a step E2, it associates contextual information with this information of ADS-B type received by the aircraft AC. This contextual information comprises a piece of information on the current position of the aircraft AC, this current position corresponding to the moment when the aircraft AC received the information of ADS-B type. The processing unit 30 receives this piece of information on the current position of the aircraft from the source of position information 34a. Advantageously, the set of sources of information further comprises a time reference 34b and the contextual information further comprises a piece of information on the time at which the information of ADS-B type was received by the aircraft AC. The time reference 34b corresponds, for example, to a clock which is internal to the aircraft or indeed to a clock which is external to the aircraft such as, for example, a time reference supplied by a satellite geolocation system.

In one embodiment, as shown in FIG. 3, the aircraft AC comprises a communication system 38 (labelled COMM in the figure). The processing unit 30 is connected at its output to this communication system. The communication system 38 is connected to an antenna ANT of the aircraft. In particular, the communication system 38 forms part of an on-board system for storing and for communicating information of the aircraft. The processing unit 30 sends the information of ADS-B type received by the aircraft, as well as the associated contextual information, to the communication system 38, which transmits it, in a step E4 of the method, to a server 20 which is common to the various aircraft AC1, AC2, AC3 belonging to the set of collecting aircraft. In the example illustrated in FIG. 1, the communication systems of the aircraft AC1, AC2, AC3 transmit the various information to the common server 20 via respective wireless links L1, L2, L3. According to one embodiment, the links L1, L2, L3 are direct links between the aircraft AC1, AC2, AC3 and the server 20. According to another embodiment, these links are indirect links between the aircraft AC1, AC2, AC3 and the server 20: for example, these links pass through different receivers for the various aircraft AC1, AC2, AC3, these receivers being, for instance, satellites, ground receivers etc. As a further example, these links follow one or more communication networks, which can be shared networks, such as an ACARS (Aircraft Communication Addressing and Reporting System) or Internet network. The server 20 stores the various information in a memory 22. According to a first alternative, the processing unit 30 sends the various information to the communication system 38 and, in the step E4, the communication system 38 transmits this information to the common server 20 while the aircraft AC is in flight. Thus, the server 20 receives the various information almost in real time. According to a second alternative, the aircraft AC further comprises a memory 36. In a step E4a, the processing unit 30 stores the various information in the memory 36 while the aircraft is in flight, then, at the end of a flight of the aircraft, when the latter has arrived at an airport, the processing unit 30 recovers the various information stored in the memory 36 during the flight and it sends it to the communication system 38, which transmits this information to the common server 20 in the step E4. According to a third alternative, when the communication system 38 forms part of an on-board system for storing and for communicating information of the aircraft, the communication system 38 comprises a memory not shown in the figure. During the flight of the aircraft, the processing unit 30 sends the various information to the communication system 38, which stores it in its memory in a step E4a. At the end of the flight of the aircraft, when the latter has arrived at an airport, the communication system 38 recovers the various information stored in its memory then transmits it to the common server 20 in the step E4.

The invention is not, however, limited to this embodiment. It also relates to an embodiment in which, in a step E4a, the processing unit 30 stores the various information in the memory 36 while the aircraft is in flight, then, at the end of a flight of the aircraft, an operator transfers this information to the server 20 by means of a physical medium. This physical medium can correspond to the memory 36 or to another medium such as, for example, a memory card onto which the operator copies the information stored in the memory 36.

The set of collecting aircraft under consideration consists of aircraft AC1, AC2, AC3, each of which comprises a processing unit 30 configured to collect, in the step E1, information of ADS-B type received from other aircraft, to associate, in the step E2, contextual information with the received information of ADS-B type and to make it possible to transmit, in the step E4, the received information of ADS-B type, as well as the associated contextual information, to a common server.

The common server 20 comprises a processing unit 21 and a memory 22. In a step E5 of the method, the processing unit 21 receives the information transmitted by the various aircraft in the set of collecting aircraft to the common server 20 and stores this information in the memory 22.

In a step E6 of the method, the processing unit 21 filters the information thus stored in the memory 22, so as to exclude information of ADS-B type which is incoherent taking into account contextual information. Advantageously, in the step E6, in addition to filtering the information, the processing unit 21 consolidates the information. As previously indicated, the contextual information comprises a piece of information on the position of the aircraft AC1, AC2, AC3 in the set of collecting aircraft which received the information of ADS-B type. This information of ADS-B type comprises a piece of information on the position of the aircraft transmitting said information of ADS-B type. If a distance between this position and the position of the aircraft AC1, AC2, AC3 in the set of collecting aircraft which received the information of ADS-B type is above a predetermined distance threshold, this distance being such that it would not have made it possible for the information of ADS-B type to be received by the aircraft AC1, AC2, AC3 in the set of collecting aircraft, then the information of ADS-B type is considered to be incoherent with the position of the aircraft AC1, AC2, AC3 in the set of collecting aircraft and the processing unit 21 excludes this information of ADS-B type.

In one particular embodiment, when the contextual information comprises a piece of information on the time at which the information of ADS-B type was received by the aircraft AC in the set of collecting aircraft which received this information originating from an aircraft transmitting said information, in the step E6 the processing unit 21 further filters the information by checking the coherence of information of ADS-B type corresponding to several moments for the same transmitting aircraft. In particular, the processing unit verifies whether the values of the positions of the transmitting aircraft for these various moments are coherent with one another taking into account the speed performance of the transmitting aircraft. The processing unit thus excludes information of ADS-B type which would not be coherent.

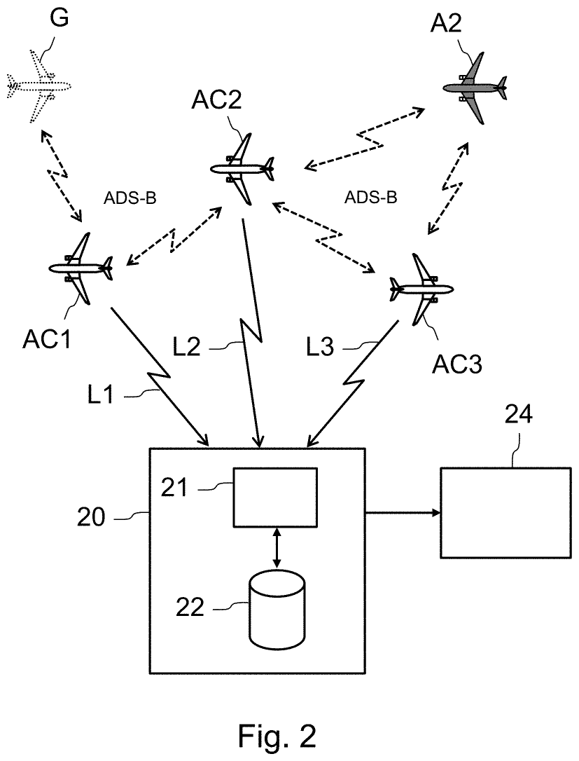

Advantageously, in the step E6 of the method, the processing unit 21 further filters the information by taking into account information received from several aircraft in the set of collecting aircraft. In the example illustrated in FIG. 2, the aircraft AC1 receives information of ADS-B type originating from the aircraft G. The position of the aircraft G contained in the information of ADS-B type corresponds to the position of the aircraft G shown in the figure. In contrast, the aircraft AC2 does not receive information of ADS-B type originating from the aircraft G. However, the aircraft AC2 is close enough to said position of the aircraft G for it too to be able to receive information of ADS-B type originating from the aircraft G. There is therefore an anomaly and the position of the aircraft G contained in the information of ADS-B type then corresponds to a “phantom” position: the aircraft AC1 received this information from a transmitter located outside the receiving range of the aircraft AC2, for example a transmitter located to the left of the aircraft AC1 in the figure. This transmitter might, for example, correspond to an aircraft intentionally or unintentionally transmitting erroneous information of ADS-B type or indeed to a ground transmitter intentionally transmitting information of ADS-B type simulating the presence of the aircraft G in the position contained in this information. In such a situation, the processing unit 21 of the common server 20 receives the information of ADS-B type from the aircraft G with which the contextual information added by the aircraft AC1 is associated. The processing unit 21 also receives the information of ADS-B type from the aircraft AC1 and AC2. The processing unit 21 comprises software configured to compare the positions of the aircraft AC1, AC2 and G contained in the various received information of ADS-B type and to detect the aforementioned anomaly. After having detected this anomaly, the processing unit excludes the information of ADS-B type coming from the aircraft G. This makes it possible to exclude information considered to be unreliable.

In a step E8 of the method, the processing unit 21 of the common server 20 transmits at least some of the filtered information to a user, or computer, 24. According to a first alternative, the user 24 corresponds to a computer using information of ADS-B type from aircraft. In one embodiment, the information of ADS-B type is sent to this computer 24 by the processing unit 21 on the initiative of the processing unit 21. In another embodiment, the processing unit 21 sends the information of ADS-B type to the computer 24 at the request of the computer 24. According to a second alternative, the user 24 corresponds to a computer terminal or to a computer used by an operator and the processing unit 21 sends the information of ADS-B type to the user 24 at the request of the operator.

Advantageously, the method further comprises a step E3, during which the processing unit 30 of the aircraft AC signs the information before transmitting it, accompanied by said signature, to the common server 20 in the step E4. This signature bears at least on the information of ADS-B type received by the aircraft AC. In one particular embodiment, the signature further bears on the contextual information associated by the processing unit 30 with the information of ADS-B type. According to a first alternative, the processing unit 30 produces a general signature bearing on all the information of ADS-B type and associated contextual information. According to a second alternative, the processing unit 30 produces a first signature on the information of ADS-B type and a second signature bearing on the contextual information. This signature is used by the processing unit 21 of the server 20 to check the integrity and the authenticity of the information received in the step E5. This makes it possible, on the one hand, to guarantee that the received information indeed corresponds to the information sent by the aircraft AC and, on the other hand, to guarantee that the information indeed originates from an aircraft in the set of collecting aircraft. In one embodiment, the processing unit checks the signature in the step E5: thus, when the received signature does not correspond to the received information, the processing unit 21 does not store this information in the memory 22. In another embodiment, in the step E5 the processing unit 21 stores the received information, as well as the signature, in the memory 22, then it checks the signature subsequently. For example, the processing unit 21 checks the signature in the filtering step E6 by excluding the information for which the signature does not correspond to this information.

In one embodiment, the information is signed in the step E3 by means of an avionic computer of the aircraft AC. As an avionic computer is subject to certification by air safety authorities, signing the information by means of such a computer makes it possible to guarantee the origin of the information received by the common server 20: specifically, this guarantees that the information received by the server indeed originate from an item of equipment installed on board an aircraft AC in the set of collecting aircraft and not from any source which might not be reliable.

Further advantageously, the method further comprises a step E7, during which the processing unit 21 aggregates the information filtered in the step E6. In one embodiment, this aggregation of the information comprises determining at least one trajectory of an aircraft depending on information of ADS-B type corresponding to this aircraft. By virtue of the invention, this trajectory is determined on the basis of information of ADS-B type considered to be reliable.

In one particular embodiment, the processing unit 21 of the common server 20 further determines an indicator of the quality of the information of ADS-B type relating to at least one aircraft. In a first example, an indicator of quality pertains to a position of an aircraft under consideration. In particular, this indicator of quality is determined as being the number of aircraft in the set of collecting aircraft which collected the corresponding information of ADS-B type, divided by the number of aircraft in the set of collecting aircraft which collected the information of ADS-B type which were located near to the aircraft under consideration. In a second example, an indicator of quality pertains to an aircraft in the set of collecting aircraft. In particular, this indicator of quality is determined as being the number of positions of collecting aircraft which this aircraft collected during a flight, divided by the number of positions of this aircraft which were collected by other collecting aircraft during this flight. The indicator of quality makes it possible for the user 24 to know what level of confidence it can have in the information supplied by the common server 20.

According to one embodiment of the invention, the common server 20 is located on the ground. In particular, the common server then forms part of a platform for collecting operating data from the aircraft in the set of collecting aircraft. However, other embodiments are possible without departing from the scope of the invention, the common server being, for example, installed on board a collecting aircraft or a satellite, or indeed the common server being distributed over several physical machines, one or more of which can be installed on board a collecting aircraft or a satellite.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A method for collecting flight data from aircraft, the method comprising:
collecting, from each aircraft in a set of collecting aircraft, ADS-B information received from other aircraft;
on board each aircraft in the set of collecting aircraft, associating contextual information with the ADS-B information received by the respective aircraft;
transmitting, by each aircraft in the set of collecting aircraft, the received ADS-B information, as well as the associated contextual information, to a common server;
the common server receiving and storing the received ADS-B information and the associated contextual information transmitted by the aircraft in the set of collecting aircraft;
filtering the received ADS-B information and the associated contextual information stored by the common server so as to exclude ADS-B information which is incoherent taking into account contextual information; and
transmitting at least some of the filtered information to a user.

2. The method according to claim 1, wherein the contextual information comprises at least one piece of information on a position of the aircraft in the set of collecting aircraft which received the ADS-B information with which the contextual information is associated.

3. The method according to claim 1, wherein the contextual information comprises a piece of information on a time at which the ADS-B information was received by the aircraft in the set of collecting aircraft which received this ADS-B information with which the contextual information is associated.

4. The method according to claim 1, further comprising:
signing, on board an aircraft in the set of collecting aircraft, the ADS-B information received by the respective aircraft, before transmitting the ADS-B information to the common server, and,
checking an authenticity and/or an integrity of the ADS-B information received by the common server, on a basis of said signature.

5. The method according to claim 4, wherein the signing further comprises signing the contextual information associated with the ADS-B information received by said aircraft.

6. The method according to claim 1, filtering the received ADS-B information and the associated contextual information stored by the common server comprises excluding ADS-B information which is not coherent with other ADS-B information stored by the common server, taking into account contextual information or which is not coherent with contextual information associated with this ADS-B information.

7. The method according to claim 1, further comprising:
aggregating the filtered information.

8. The method according to claim 7, wherein the aggregating comprises determining at least one trajectory of an aircraft.

9. The method according to claim 1, wherein the common server is located on the ground.

10. The method according to claim 9, wherein the common server forms part of a platform for collecting operating data from the aircraft in the set of collecting aircraft.

11. The method according to claim 1, wherein an aircraft in the set of collecting aircraft transmits information to the common server with of an on-board system for storing and for communicating information of said aircraft.

12. The method according to claim 1, further comprising:
determining at least one indicator of a quality of aggregated data.
